(19) United States
(12) Patent Application Publication
(10) Pub. No.: US 2026/0197080 A1
(43) Pub. Date: Jul. 9, 2026

(54) FREE-SPACE OPTICAL TELECOMMUNICATION SYSTEM

(71) Applicant: Cailabs, Rennes (FR)

(72) Inventor: Guillaume Labroille, Rennes (FR)

(21) Appl. No.: 19/131,598

(22) PCT Filed: Nov. 20, 2023
(86) PCT No.: PCT/EP2023/082372

§ 371 Date: May 21, 2025

(30) Foreign Application Priority Data
Nov. 21, 2022 (FR) FR2212067

(51) Int. Cl. H04B 10/112; H04B 10/118; H04B 10/2581

(52) U.S. Cl. CPC H04B 10/1121; H04B 10/118; H04B 10/2581

(57) ABSTRACT

A free-space optical telecommunication system includes a telescope having an objective lens for collecting incident light radiation and producing, at an optical port, a first light radiation; an optical processing device and at least one polarization-maintaining multimode waveguide having a first end coupled to the optical port of the telescope and a second end coupled to the optical processing device.

### CROSS-REFERENCE TO RELATED APPLICATIONS

This application is a national phase entry under 35 U.S.C. § 371 of International Patent Application PCT/EP2023/082372, filed Nov. 20, 2023, designating the United States of America and published as International Patent Publication WO 2024/110378 A1 on May 30, 2024, which claims the benefit under Article 8 of the Patent Cooperation Treaty of French Patent Application Serial No. FR2212067, filed Nov. 21, 2022.

### TECHNICAL FIELD

The disclosure relates to an optical telecommunication system seeking to compensate for the distortion of the wavefront of an incident light radiation. This distortion may originate in atmospheric disturbances during an optical communication in free space. More generally, this distortion is caused by the propagation of the light beam in its medium. The disclosure has particular applications in the field of free-space optical telecommunications.

### BACKGROUND

In free-space optical telecommunication, a transmitter modulates light radiation (usually produced by a laser) with information to be transmitted, the light radiation taking the form of a narrow beam which is emitted in the direction of a receiver. After propagation in its medium (air will be used as an example in the remainder of this description, but the medium can be of any nature, such as water in the case of underwater telecommunication), the light radiation is collected at a receiver and demodulated to recover the transmitted information. Generally speaking, and with the aim of maximizing the data rate, it is sought to exploit as much of the energy present in the light radiation received by the receiver as possible, in order to maximize the transmission rate.

To multiply communication channels and maximize throughput, light radiation can be multiplexed in wavelength and/or polarization.

The propagation of light radiation subjects the radiation produced by the transmitter to atmospheric disturbances, and in particular to the variations in temperature and pressure that the radiation undergoes during its propagation. These erratic disturbances, the variation dynamics of which is typically between 100 Hz and several kHz, lead to its deformation, which affects its wavefront. More precisely, disturbances tend to spatially redistribute energy in the radiation, producing random fluctuations in amplitude and phase. This deformation materializes in the form of “speckle” patterns in the spot formed by the projection of the beam onto the radiation collection device and by a scintillation phenomenon. This limits the data rate on the link between the transmitter and the receiver.

To overcome this limitation, it is known (e.g., from documents WO2022185020 and US20170070289) to provide adaptive optics to compensate for these phenomena. However, this type of solution is limited in performance, as it only affects the phase of the incoming light. Document EP3672109A1 proposes a receiver capable of modally decomposing the radiation received (at a collector) into elementary rays. These elementary rays are coherently recombined by a photonic device. Document WO2016047100 proposes, after modal decomposition of the received radiation, to electrically convert the elementary radiations in order to process these signals in a digital processing device.

Coherent recombination of elementary light rays requires perfect control of their polarization. These radiations must have the same polarization to enable the interference mechanism that produces the desired recombination.

It will be noted that the light radiation produced by the transmitter is polarized, and that this polarization is not affected by the free-space propagation of the light radiation. Conversely, the propagation of this light radiation in the receiver can affect its polarization, particularly when the optical processing of this radiation is to be offset from the collector via an optical fiber.

Depending on the chosen communication protocol, the polarization state of the light radiation produced by the transmitter can be determined (e.g., linear, left-hand circular or right-hand circular polarization) or undetermined. In the latter case, its characteristics can evolve freely over time. Even when the polarization state of the light radiation has been determined, any relative displacements between the transmitter and the receiver can lead to changes in its characteristics at the receiver. This is particularly the case when the transmitter is located in a satellite and the latter is likely to rotate on itself.

In addition, and as previously mentioned, some communication protocols also provide for the production of polarization multiplexed light radiation.

It is therefore clear that the light radiation received by the receiver has a polarization state that is not always perfectly controlled, but which must be taken into account in order to make the most of the transmitted energy and/or to decode the transmitted symbols.

This is particularly true when the receiver processes the received light using a coherent combination of elementary beams, and when this processing is remote from the collector.

### BRIEF SUMMARY

One object of the present disclosure is to propose an optical communication system which at least partially overcomes the aforementioned problems. More precisely, one object of the disclosure is to provide an optical communication system comprising a collector of incident light radiation and a photonic device implementing a coherent combination of elementary light radiations, the photonic device being remote from the collector.

With a view to achieving this object, the subject matter of the present disclosure proposes a free-space optical telecommunication system comprising:
a telescope having an objective lens for collecting incident light radiation and producing, at an optical port, a first light radiation;
an optical processing device comprising:
   a mode splitter comprising a modal decomposition device configured to decompose the first light radiation, the mode splitter producing a plurality of elementary light radiations;
   a photonic device optically coupled to the mode splitter, the photonic device being configured to coherently recombine at least some of the elementary light radiations and produce at least one recombined light radiation;
at least one polarization-maintaining multimode waveguide with a first end coupled to the optical port of the telescope and a second end coupled to the optical processing device.

According to other advantageous non-limiting features of the disclosure, taken alone or according to any technically feasible combination:
the modal decomposition device comprises at least one multiplane conversion device;
the modal decomposition device comprises a bundle of single-mode optical fibers assembled in parallel;
the modal conversion device preserves at least one polarization state of light radiation propagating therein, and the mode splitter comprises a polarization conditioning device configured to conform the first light radiation to the preserved polarization state of the modal conversion device;
the optical telecommunication system comprises a polarizing beam splitter arranged upstream of the photonic device, the optical splitter producing a first plurality of elementary light radiations and a second plurality of elementary light radiations having distinct polarizations, the first plurality and the second plurality of elementary light radiations constituting the plurality of elementary light radiations;
the polarizing beam splitter is coupled to the second end of the multimode waveguide, the polarizing beam splitter producing a first polarized light radiation and a second polarized light radiation with distinct polarizations;
the polarizing beam splitter is arranged in the optical port of the telescope to produce a first polarized light radiation and a second polarized light radiation having distinct polarizations, the polarizing beam splitter being arranged in the optical port to inject the first polarized light radiation into a first polarization-maintaining multimode waveguide and to inject the second polarized light radiation into a second polarization-maintaining multimode waveguide;
the mode splitter comprises a first modal decomposition device arranged to receive the first polarized light radiation and produce a first plurality of elementary light radiations and a second modal decomposition device arranged to receive the second polarized light radiation and produce a second plurality of elementary light radiations, the first plurality and the second plurality of elementary light radiations constituting the plurality of elementary light radiations produced by the mode splitter;
the modal decomposition device is coupled to the second end of the multimode waveguide to produce a plurality of decomposed light radiations, and the polarizing beam splitter is optically arranged downstream of the modal decomposition device to receive the plurality of decomposed light radiations and produce the first plurality of elementary light radiations and the second plurality of elementary light radiations;
the photonic device is configured to produce a first recombined light radiation from the first plurality of elementary light radiations and to produce a second recombined light radiation from the second plurality of elementary light radiations;
the photonic device comprises a first photonic device optically coupled to the mode splitter for receiving the first plurality of elementary light radiations and producing the first recombined light radiation, and a second photonic device optically coupled to the mode splitter for receiving the second plurality of elementary light radiations and producing the second recombined light radiation;
the photonic device comprises a recombination device configured to recombine the first and second recombined radiation to form a single recombined light radiation;
the recombination device is configured to form a single recombined light radiation with a single polarization;
the recombination device is configured to form a single recombined light radiation with superimposed polarizations;
the optical port comprises a device for static or dynamic control of the polarization of the incident radiation to conform it to a determined polarization before it is injected into the multimode waveguide;
the photonic device is optically coupled to the mode splitter via a plurality of single-mode optical fibers;
the single-mode optical fibers of the plurality of single-mode fibers are polarization-maintaining;
the coupling between the photonic device (C) and the mode splitter(S) is devoid of optical fibers
the optical telecommunication system comprises an optical receiver for demodulation of the optically recombined light radiation coupled to the optical processing device (DR);
the mode splitter comprises a shaping device arranged upstream of the modal decomposition device;
the second end of the polarization-maintaining multimode waveguide is directly coupled to an input port of the mode splitter.

### BRIEF DESCRIPTION OF THE DRAWINGS

Other features and advantages of the disclosure will emerge from the following detailed description of embodiments of the disclosure with reference to the accompanying figures, in which:

FIG. 1 shows an optical telecommunication system according to the disclosure;

FIGS. 2A-2D show different embodiments of the optical telecommunication system shown in FIG. 1;

FIGS. 3A and 3B show two . . . s of a photonic device used in the optical telecommunication system of FIG. 1; and

FIG. 4 shows an MPLC device of an optical telecommunication system according to the disclosure.

### DETAILED DESCRIPTION

### Elements Common to all Embodiments

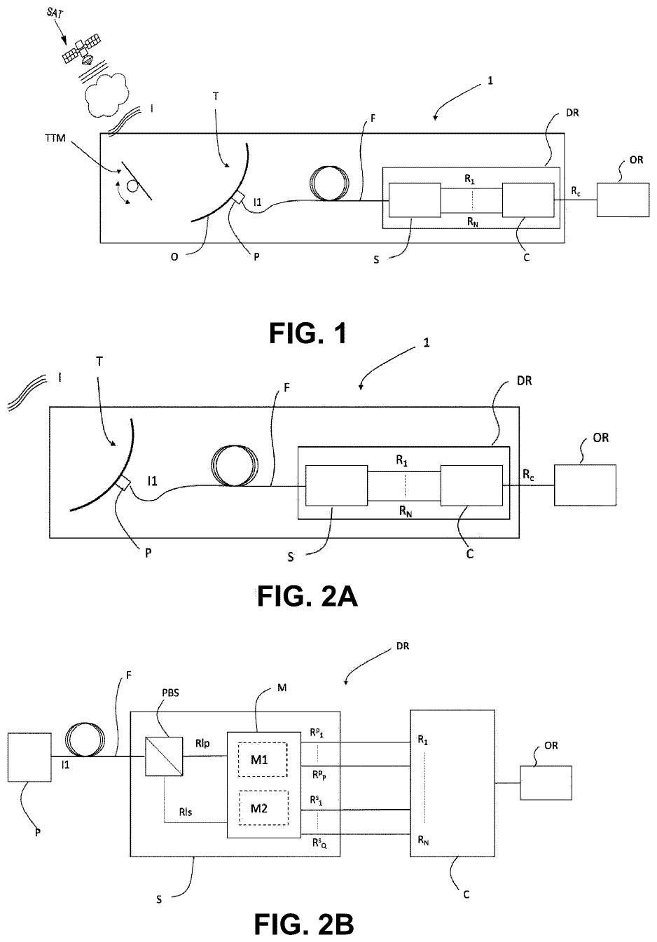

With reference to FIG. 1, an optical telecommunication system 1 conforming to the disclosure is designed to process incident light radiation I produced by a transmitter and carrying, by modulation, information to be transmitted. The incident light radiation I may have several wavelengths, as is usually the case for WDM type transmissions, and/or may use several polarizations. The incident light radiation, once processed by the optical telecommunication system 1, is supplied to an optical receiver OR of a base station, capable of extracting information from the received radiation.

In the example shown in FIG. 1, the transmitter is arranged in a satellite SAT, but the telecommunication system of the disclosure is by no means limited to this particular application. Generally speaking, the transmitter can be positioned on land, at sea or in space, and propagate in any free space, the atmosphere in the case of land communication, or water in the case of marine communication. The transmitter and the telecommunication system 1 can be stationary, or move relative to one another.

The incident light radiation I emitted takes the form of a narrow beam directed toward the telecommunication system 1. During its propagation in free space, the radiation emitted is subjected to atmospheric disturbances of the atmosphere, so that the incident light radiation I arriving at the base station has amplitude and phase spatial and temporal fluctuations. This phenomenon affects the shape of this radiation, which takes a variable shape over time, erratically and irregularly. The optical telecommunication system 1 is designed to compensate, at least in part, for this distortion, so that the optical receiver OR can process the radiation and decode the transmitted message by direct or coherent detection. For this purpose, the receiver OR may incorporate amplification and/or spectral demultiplexing functions, particularly for WDM transmission.

The optical telecommunication system 1 comprises a telescope T, said telescope T having an objective lens O for collecting incident light radiation I and producing, at an optical port P, a first light radiation I1. As is well known per se, this objective lens can comprise a concave mirror focusing the radiation received at an image focus. This convergent radiation can be reflected back to the optical port P using a second mirror of the objective lens O, which can be flat or convex. The second mirror, when present, leads to the formation of a central zone of very low intensity in the light radiation propagating toward the optical port P. In all cases, this optical port P of the telescope T therefore produces the first radiation I1. This telescope T can be rotated to point and track the transmitter, here located in the satellite SAT. The telescope T can also comprise a device for guiding the incident radiation TTM (such as a tip tilt mirror) in order to best guide the light radiation toward the optical port P, for example, to center this radiation in the port P and, more generally, to correct any pointing deviations of the telescope T.

Returning to the description in FIG. 1, the optical telecommunication system 1 also comprises, optically downstream of the telescope T, an optical processing device DR designed to compensate, at least in part, for distortions in the incident light radiation I collected. This device DR, which will be described in detail in a subsequent section of this disclosure, is made up of a plurality of precisely assembled optical or photonic elements, which may be particularly sensitive to their operating environment. It is therefore advantageous to offset this system of the telescope T, whose positioning is often dictated by the reception quality of the incident radiation I, by a few meters to several tens of meters, for example, to place it in a cabinet, a room, in a vehicle or any other shelter of a base station operations center. In this way, the optical processing device DR can be protected, its operating environment controlled (temperature, atmosphere, exposure to dust, vibrations, movements, etc.) and its operation and maintenance made easier.

To enable this distance between the telescope T and the rest of the optical telecommunication system 1, the optical port P of the telescope is optically connected to the optical processing device DR via a polarization-maintaining multimode waveguide F. A first end of this waveguide F is coupled to the optical port P of the telescope T and a second end of the waveguide F is coupled to the optical processing device DR. It propagates the first light radiation I1 produced by the optical port P to the optical processing device DR.

Advantageously, this waveguide has a length of at least one meter, and typically between 1 m and 10 m, enabling the optical processing device DR to be offset sufficiently from the telescope T to, for example, house it.

The waveguide F can be passive or active, in which case it incorporates an additional amplification function.

“Polarization-maintaining” means that the waveguide has, over its length, a polarization extinction ratio (PER) greater than 7 dB, advantageously greater than 10 dB and even more advantageously greater than 20 dB.

By way of example, this waveguide F can be formed by at least one multimode optical fiber, active or passive, comprising at least one elliptical core and having a parabolic index gradient or a step-index gradient. The size of the core is chosen to enable a plurality of modes to be propagated, for example, at least 10 modes or at least 50 modes. The multimode optical fiber can be a spun optical fiber. Such a fiber is created by rotating a polarization-maintaining preform during drawing. It can be used to propagate circularly polarized light, while preserving this polarization. The multimode optical fiber can also comprise stress bars, integrated into the preform prior to drawing, to correspond to a Panda, Bowtie or Elliptical stress layer fiber.

The waveguide F can be formed by a bundle of polarization-maintaining multimode optical fibers.

Maintaining polarization can involve two specific linear polarization states of the waveguide, for example, along two orthogonal axes arranged in a plane transverse to the direction of propagation. Maintaining polarization can alternatively relate to two circular polarization states, as has been shown in relation to spun optical fiber.

In some cases, it may be advantageous to provide a device for conditioning the polarization of the light radiation injected into the waveguide, this device being arranged in the optical port P and coupled to the first end of the waveguide. This device is designed to conform the polarization of the light collected by the objective lens of the telescope T to the polarization states maintained by the waveguide. It is particularly useful when the polarization of the incident radiation I is not perfectly controlled, and it is therefore not possible to inject this radiation collected by the telescope T directly into the waveguide F without risking affecting the polarization of the radiation propagating through it.

“Polarization conditioning device” is understood to mean any means (passive device or static or dynamic control device) for transforming the nature (linear, circular) and/or orientation of the polarization of incident light radiation. In particular, it can be a simple half-wave or quarter-wave phase plate (or retardation plate).

By way of example, which can be applied to each of the embodiments that will be set out in the present description, it is possible to measure, totally or partially, the polarization state of the incident light radiation by means of a polarimeter and to correct it accordingly using motorized or static birefringent retardation plates, or liquid crystal or Pockels birefringent cells. Please refer to the article by T. Chiba, Y. Ohtera and S. Kawakami, “Polarization stabilizer using liquid crystal rotatable waveplates,” in Journal of Lightwave Technology, vol. 17, no. 5, pp. 885-890, May 1999, for an example of such a device for controlling the polarization of light radiation.

In general, reference may be made to the chapter “Polarization Measurement” by Soe-Mie F. Nee, in “Measurement, Instrumentation, and Sensors Handbook” edited by John G. Webster, Halit Eren and published by CRC Press (ISBN 9781315217444) for basic principles of light polarization.

In all cases, and whether or not a polarization conditioning device is provided, the first light radiation I1 exhibits a controlled polarization after its propagation in the waveguide F, when it arrives at the optical processing device DR. “Controlled” is understood to mean that propagation in the waveguide is not subject to crosstalk, and that the energies present in the different polarization states of the first light radiation I1 are preserved during this propagation.

Generally speaking, the optical processing device DR comprises a mode splitter S optically coupled to the waveguide F. The mode splitter S has an input port and an output port. It comprises at least one modal decomposition device configured to decompose the first light radiation I1 supplied by the waveguide F at the first input port and produce, at its output port, a plurality of elementary light radiations R₁-R_{N}. Advantageously, the elementary radiations R₁-R_{N} are single-mode and all have the same polarization state.

A polarization-conditioning device can be placed in the mode splitter S, between the waveguide F and the modal decomposition device, in order to conform, if this is not already the case, the polarization of the radiation supplied by the waveguide F to the polarization preserved by the modal decomposition device. A further polarization-conditioning device may also be provided in the mode splitter S, optically downstream of the modal decomposition device, to conform the polarization of the elementary light radiations R₁-R_{N} to the polarization expected by the devices arranged downstream of the splitter S.

The optical processing device DR also comprises, optically downstream and coupled to the mode splitter S, at least one photonic device C. This photonic device C is configured to coherently recombine at least some of the elementary light radiations R₁-R_{N} and produce at least one single-mode recombined light radiation R_{c}.

By modal decomposition of the first radiation I1 and coherent recombination of the elementary radiations R₁-R_{N} produced, the optical processing device DR makes it possible to exploit the maximum energy of the incident light radiation I collected and to compensate, at least in part, for the distortion undergone by this radiation during its propagation in free space. Since the elementary radiations R₁-R_{N} have identical polarization states, they can be efficiently and coherently recombined with one another, that is, form a single-mode recombined light radiation R_{c} with maximum energy.

The mode splitter S and the photonic device C can be coupled together in different ways, using optical fibers or without any optical fibers at all, while preserving the polarization states of the elementary radiations R₁-R_{N} affecting them identically.

The two devices can thus be separated from one another, and the elementary radiation R₁-R_{N} propagates in free space between the two devices.

Alternatively, a fiber bundle, for example, a single-mode fiber bundle, can be used to guide the propagation of the elementary radiations R₁-R_{N}. Advantageously, these single-mode fibers are polarization-maintaining.

Alternatively, the two devices can be configured for mechanical assembly, with the output port of the mode splitter device S facing the input port of the photonic device C, so that elementary radiation can propagate from one device to the other.

As already mentioned, a polarization-conditioning device can be arranged in the mode splitter S or between the mode splitter S and the photonic device C, so as to adapt the polarization of some or all of the elementary radiations R₁-R_{N}, to the polarization expected by the photonic device C or to the expected polarization of the single-mode fibers, when such fibers are used to guide the propagation of the elementary radiations R₁-R_{N} to the photonic device C, respectively.

The modal decomposition device M of the mode splitter S can be implemented by a multi-plane light converter device, referred to as “MPLC device” in the remainder of this description. For the sake of completeness, it is recalled that in such an MPLC device, incident light radiation undergoes a succession of reflections and/or transmissions, each reflection and/or transmission being followed by free-space propagation of the radiation. At least some of the optical parts on which the reflections and/or the transmissions take place, and which guide the propagation of the incident radiation, have microstructured zones which modify the incident light radiation.

The term “microstructured zone” means that the surface of the optical part has on this zone a relief, which can, for example, be broken down in the form of “pixels” whose dimensions may be comprised between a few microns and a few hundred microns. It may be metasurfaces. The relief or each pixel of this relief has a variable elevation with respect to a mean plane defining the surface in question, of at most a few microns or at most a few hundreds of microns. Regardless of the nature of the microstructuring of the zones, an optical piece having such zones forms a phase mask introducing a local phase shift within the transverse section of the beam which is reflected there or transmitted there.

Thus, a light radiation which propagates within an MPLC device undergoes a succession of local phase shifts separated by propagations. The succession of these elementary transformations (for example, at least four successive transformations such as 8, 10, 12, 14, or even at least 20 transformations, for example) establishes an overall transformation of the spatial profile of the incident radiation. It is thus possible to configure the microstructured reflection or transmission surfaces to transform a first light radiation, which in particular has a specific shape, into a second radiation whose shape is different.

The documents “Programmable unitary spatial mode manipulation,” Morizur et al., J. Opt. Soc. Am. A/Vol. 27, No. 11/November 2010; N. Fontaine et al., (ECOC, 2017), “Design of High Order Mode-Multiplexers using Multiplane Light Conversion”; U.S. Pat. No. 9,250,454 and US2017010463 contain the theoretical foundations and examples of practical implementation of an MPLC device.

As shown in detail in the aforementioned documents, the microstructured zones carried by the optical component(s) forming the MPLC device are designed and configured to operate modal conversion aimed at decomposing the light radiation received on the input port in a family of modes called “input” modes. The energies present in the modes of the input family are transported and respectively shaped to modes of a family of “output” modes at the output port of the MPLC device. The MPLC device is configured to respectively match the input base modes and the output base modes. This is a passive device with a particularly stable and robust transfer function, which also has little or no effect on certain polarization states of the light radiations passing through it.

An MPLC device is generally made up of optical components with parallel main surfaces on which multiple reflections and/or transmissions take place. In such a configuration, the polarization states preserved during radiation propagation in the device concern:
the s-polarization state, that is, a state perpendicular to the radiation propagation axis and parallel to the planes defined by the main reflection and/or transmission surfaces;
the p-polarization state, that is, a state also perpendicular to the propagation axis and perpendicular to the planes defined by the main reflection and/or transmission surfaces.

The aim is thus to ensure that the radiation injected into such an MPLC device exhibits s- and/or p-polarization.

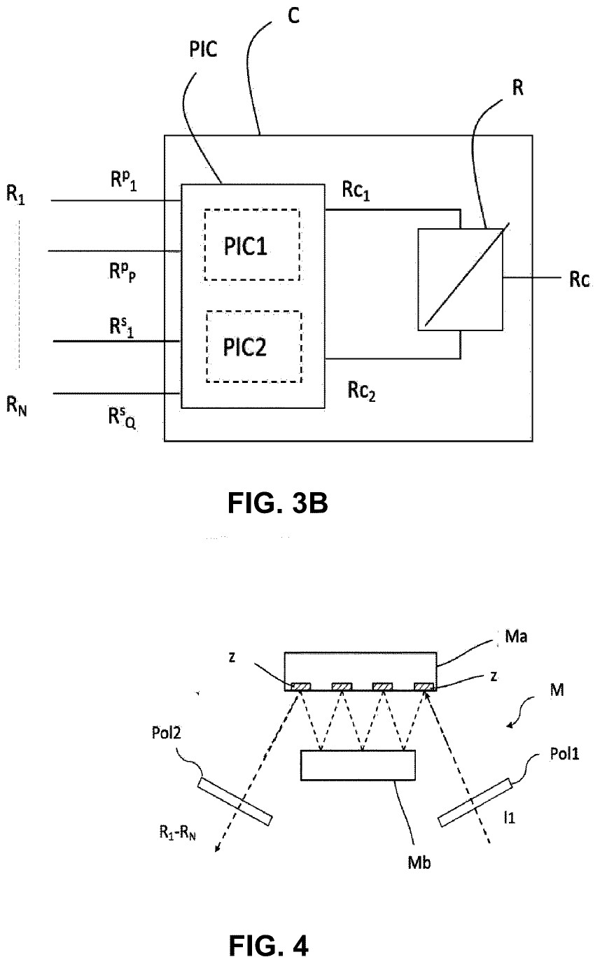

For purposes of illustration, FIG. 4 shows such an MPLC device M comprising two optical parts Ma,Mb arranged opposite one another, these optical parts having mutually parallel surfaces whereupon the first radiation I1 is reflected (at microstructured zones z), a plurality of times, to decompose it into elementary radiations R₁-R_{N}. In the illustration in FIG. 4, only one of these optical parts Ma carries these microstructured zones z, but it is entirely possible to have them carried by both optical parts Ma, Mb or by any other combination of optical parts. Also shown in FIG. 4 are two polarization conditioning devices Pol1 and Pol2. The first Pol1 of these devices conforms the polarization of the first radiation I1 to conform its polarization to that maintained by the MPLC device M. It may be, for example, a delay, half-wave or quarter-wave plate, as previously mentioned. Similarly, a second polarization conditioning device, Pol2, is located at the output of the MPLC device M, to intercept the elementary radiations R₁-R_{N} and adjust their polarization to that expected by the optical device located further downstream.

In the context of the present description, and by way of example, the family of input modes may comprise a Hermite-Gaussian base made up of N Hermite-Gaussian modes, arranged spatially opposite the first light radiation I1. The family of output modes can be formed by N spatially separated Gaussian modes, these modes defining the elementary radiations R₁-R_{N}. The MPLC device is configured to associate a Hermite-Gaussian mode of the input base with a Gaussian mode of the output base. The energy of the first radiation I1 received at the input port is decomposed according to the input base modes and transported in the MPLC device to distribute and conform to the output Gaussian modes with which the input base modes are associated.

Of course, the Hermite-Gaussian and Gaussian modes used as examples are for illustrative purposes only, and other modes could be chosen to perform the decomposition.

The modal decomposition device M of the mode splitter S can be implemented by other means than the MPLC device taken as an example and detailed above. For example, this modal decomposition device M can be formed by a bundle of N single-mode optical fibers assembled parallel to one another and, if required, collimated with microlenses. This bundle of fibers is arranged opposite the waveguide F to receive the first light radiation I1, decompose it spatially via the N fibers of the bundle and thus produce the elementary light radiations R₁-R_{N}.

The bundle of fibers can be arranged in a matrix, or more generally, the ends of the fibers in the bundle can be arranged in a plane, for example, in the shape of a disk or inscribed in a disk, to best decompose the first light radiation I1. The fiber bundle can be arranged so that the ends of the fibers are arranged in a ring, the central part of the ring not being provided with fibers and corresponding to the central zone of very low intensity that may be present in the first light radiation I1, when this comes from a telescope T having a second mirror, as previously presented. Alternatively, the fiber ends of the bundle can be arranged in a line. In this case, an optical device can be arranged between the second end of the waveguide F and the fiber bundle, to shape the first light radiation coming from this waveguide, and conform it to the line defined by the ends of the fibers in the bundle.

Alternatively, the modal decomposition device M (and the mode splitter S) can be integrated into the photonic device C itself, this device having, for example, an input port formed by a bundle of single-mode waveguides (e.g., of Gaussian type, close to Gaussian type or of any other type), arranged one against the other, in line or in matrix, in order to spatially decompose the first light radiation I1. Each of the waveguides can be fitted with a microlens to promote the decomposition of the first light radiation I1 and its coupling to the waveguides of the photonic device C. When the photonic device C uses a photonic chip, the latter can be equipped on one of its surfaces with a plurality of grating couplers, arranged in a grid onto which the first radiation I1 is projected, each coupler decomposing part of the first radiation to inject it into a waveguide buried in the chip and of which it forms the end.

Naturally, the mode splitter S can be designed to combine these different embodiments of the modal decomposition device M, for example, by combining an MPLC device with a fiber bundle.

In all cases, care is taken to ensure that the polarization of the light radiation propagating in the mode splitter S is not excessively affected. In particular, by providing a polarization conditioning device, the aim is to ensure that the radiation injected into the modal conversion device has a polarization state that conforms to the polarization state preserved by this device.

The person skilled in the art will know how to choose the right polarization conditioning device depending on the nature of the radiation I1 coming from the waveguide and the nature of the polarization preserved by the modal conversion device. For example, this may be a half-wave plate to adjust the orientation of a linear polarization by 45°, or a quarter-wave plate to transform a circular polarization (typically from a spun fiber polarization-maintaining waveguide) into a linear polarization.

However, this polarization conditioning device is not mandatory. This is the case, for example, when the first radiation from the waveguide F has at least one of the s- and p-polarization states of an MPLC device like the one shown in FIG. 4. In this case, it must simply be ensured that the eigenaxes of the waveguide F are arranged according to these two s and p orientations of the MPLC device.

Generally speaking, and regardless of the embodiment chosen for the modal decomposition device M, an optical device for shaping the first radiation I1 originating from the waveguide F can be provided, this device being arranged in the mode splitter S upstream of the modal decomposition device M, between the second end of the waveguide F and the modal decomposition device M itself. This optical device may comprise or consist exclusively of at least one passive optical element for transmission or reflection, for example, one or more free-form optics.

Advantageously, the second end of the polarization-maintaining multimode waveguide F is directly coupled to an input port of the mode splitter S, that is, there is no other element between this second end and the mode splitter. The light radiation from the waveguide F, after any processing for shaping or polarization conditioning (as described above), is injected directly into the modal decomposition device M.

As already stated, the photonic device C is configured to coherently recombine at least some of the elementary light radiation R₁-R_{N} to produce at least one recombined light radiation R_{c}. The recombined light radiation R_{c} is single-mode and is supplied to the optical receiver OR by simple free-space propagation, for example, or preferentially via a single-mode fiber.

The photonic device C can take the form of a photonic integrated circuit PIC (or a plurality of photonic integrated circuits). The circuit then comprises waveguides to guide the elementary radiation R₁-R_{N} that arrives at its input port, and phase actuators to adjust the relative phase of this radiation and ensure that it recombines as accurately as possible to produce the recombined radiation R_{c}. An example of such a circuit is, for example, described in document EP3672109A1.

The photonic device C may take other forms than a photonic integrated circuit PIC, or comprise other components to achieve coherent recombination of the elementary radiations R₁-R_{N}. Provision may in particular be made for this recombination to be implemented by one or a plurality of multi-plane light conversion devices configured to carry out this recombination as, for example, exemplified in application FR2111490.

### First Embodiment

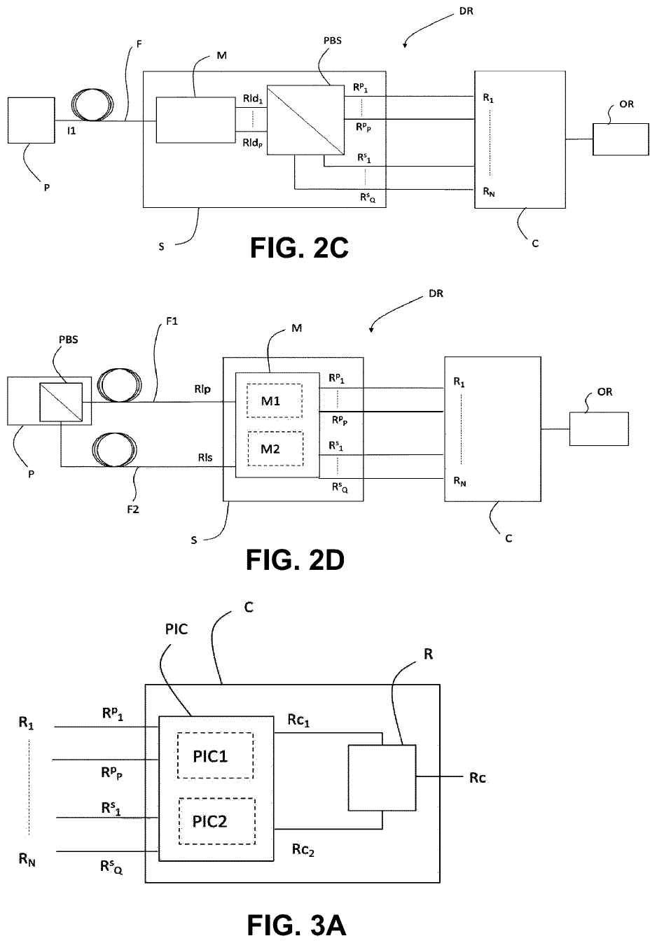

FIG. 2A shows a first embodiment particularly suited to a situation wherein the polarization of the incident light radiation I is not multiplexed and is perfectly determined. For example, transmission can take place from a fixed transmitter according to a protocol that imposes a specific polarization state on the incident radiation I, such as linear or circular. Alternatively, transmission can take place from a transmitter that is mobile in the frame of reference linked to the optical communication system, and the communication protocol imposes circular polarization of the incident radiation I.

In this first embodiment, the multimode waveguide F can be formed by a polarization-maintaining multimode optical fiber, the optical fiber being chosen and coupled to the telescope's optical port P to propagate the incident radiation I without affecting its polarization. As we have seen, this multimode optical fiber can be chosen to maintain the linear or circular polarization of the incident radiation I propagating through it. In other words, the multimode optical fiber F is chosen so that the polarization state maintained corresponds to the determined polarization state of the incident radiation I. In the case of linear polarization of this incident radiation, this fiber is coupled to the optical port in such a way that the polarization-maintaining axis of the multimode fiber is aligned with the polarization axis of the incident radiation I.

In this first embodiment, the optical port P of the telescope T may be devoid of a device for conditioning the polarization of the incident light radiation I. The latter is injected directly into the waveguide F and constitutes the first light radiation I propagating there. If, however, the polarization of the incident light radiation I is not perfectly determined, a conditioning device can be placed in the optical port P of the telescope T, as will be detailed in another section of this description.

The processing device DR of this first embodiment is fully compliant with that described in the general description above. For example, as shown in FIG. 2A, although this is not the only way of implementing this first embodiment, the mode splitter S may comprise a single modal decomposition device M, e.g., a multiplane conversion device producing a plurality of elementary light radiations, e.g., 10, 20, 50 or 100 radiations. These elementary radiations all have the same polarization as the incident radiation I and are recombined by a single photonic device C to produce at least one single-mode recombined light radiation R_{c}. A conditioning device, or a plurality of such devices, can be placed in the processing device DR to adjust the polarization of the radiation propagating through it, and to ensure that prior to each processing operation carried out on this radiation, its polarization conforms to that expected, that is, conforms to a polarization that will not be excessively affected by the processing in question.

### Second Embodiment

This embodiment shown in FIG. 2B is particularly suited to a situation wherein the incident light radiation I is polarization multiplexed, the polarizations being perfectly determined. For example, two multiplexed polarizations can be linear or circular, and orthogonal to one another.

As in the first embodiment, the multimode waveguide F can be formed from a polarization-maintaining multimode optical fiber, the optical fiber being selected and coupled to the telescope's optical port P to propagate the polarization-multiplexed incident radiation I without affecting its polarizations. The first radiation I1 to propagate in the waveguide has the same characteristics as the incident radiation I.

In the second embodiment, a polarizing beam splitter PBS is optically arranged between the waveguide F and the mode splitter S of the optical processing device DR. The polarizing beam splitter PBS can be integrated into the mode splitter S, for example, integrated into a polarization conditioning device located in the splitter upstream of the modal decomposition device M. The polarizing beam splitter PBS is therefore coupled to the second end of the multimode waveguide F, in alignment with this waveguide, so that the two polarized radiations of the first light radiation I1 are present at the splitter output.

The polarizing beam splitter PBS produces a first polarized light radiation R1p and a second polarized light radiation Ris, the first and second polarized light radiations R1p, R1s having distinct, generally orthogonal polarizations. In the polarization conditioning device, preferably upstream of the splitter device PBS, optical elements (e.g., a retardation plate) can be provided to prepare the first radiation for this orthogonal polarization, if this radiation does not naturally occur in this form.

In this configuration, the two polarized light radiations R1p, R1s propagate toward separate inputs of the input port of the modal decomposition device M. The latter is configured to decompose these two radiations R1p, R1s and supply the elementary light radiations R₁-R_{N}. More precisely, the modal decomposition device M is configured to decompose the first polarized light radiation R1p into a first plurality of elementary light radiations R^{p}₁-R^{p}_{P} and to decompose the second polarized light radiation Ris into a second plurality of elementary light radiations R^{s}₁-R^{s}_{P}. These two pluralities of elementary light radiations R^{p}₁-R^{p}_{P},R^{s}₁-R^{s}_{Q} have distinct polarizations, respectively identical to those of the first and second polarized light radiations R1p, R1s. Therefore, before the photonic device C, or even before the MPLC device, retardation plates or any other polarization conditioning device can be provided, enabling the polarization state of certain propagating radiations to be modified in order to facilitate their processing by the photonic device or their injection into single-mode fibers. The first plurality and the second plurality of elementary light radiations R^{p}₁-R^{p}_{P},R^{s}₁-R^{s}_{P} constitute, in combination, the plurality of elementary light radiations R₁-R_{N} produced by the mode splitter S.

The modal decomposition device M can be formed by two independent devices, for example, two secondary MPLC devices M1, M2 which are independent of one another, that is, equipped with separate optical parts processing the first and second polarized light radiations R1p, R1s separately. However, this is not an essential feature, and the two polarized light radiations R1p, R1s can also be decomposed by a single modal decomposition device, for example, a single MPLC device M.

Note that this second embodiment remains compatible with light radiation that is not polarization-multiplexed, and that this polarization can also be indeterminate. A portion of the energy present in the incident radiation can be collected on each of the polarization axes of the multimode waveguide F. This energy is recombined in the processing device.

The ability to process multiplexed and non-multiplexed radiation of indeterminate polarization is a particular advantage of this design, which makes the optical communication system 1 capable of decoding messages transmitted by the transmitter SAT for a plurality of communication protocols. Note that this advantage is obtained at the cost of a modal decomposition involving twice as many elementary light radiations (all other things being equal).

FIG. 2C shows a variant of the second embodiment just described. According to this variant, the modal decomposition device M of the mode splitter S is coupled to the second end of the multimode waveguide F. It produces a plurality of decomposed light radiations (R1d₁-R1d_{P}), as detailed in a previous passage. This mode splitter M can thus be implemented by an MPLC device. Upstream of the modal decomposition device M, the mode splitter S can include a polarization conditioning device.

The mode splitter S also comprises a polarizing beam splitter PBS arranged, in this variant, optically downstream of the modal decomposition device M. This splitter can be part of a polarization conditioning device implementing the other functions already described for such a device. The polarizing beam splitter PBS thus receives the plurality of decomposed light radiations R1d₁-R1d_{P} and produces a first plurality of elementary light radiations R^{p}₁-R^{p}_{P} and a second plurality of elementary light radiations R^{s}₁-R^{s}_{Q}, the first plurality and the second plurality of elementary light radiations R^{p}₁-R^{p}_{P},R^{s}₁-R^{s}_{Q} having distinct polarizations. In combination, they constitute the plurality of elementary light radiations R₁-R_{N} produced by the mode splitter S.

Whether the variant shown in FIG. 2B or that shown in FIG. 2C is implemented in the optical processing device DR of the second embodiment, the mode splitter S therefore produces a first plurality of elementary light radiations R^{p}₁-R^{p}_{P} and a second plurality of elementary light radiations R^{s}₁-R^{s}_{Q}. These two pluralities of elementary light radiations naturally have distinct polarizations. As already mentioned, wave plates or any other form of polarization-conditioning device can be provided to place these elementary light radiations (or part of them) in a chosen polarization state, for example, a polarization state expected by the photonic device C. The elementary light radiations are propagated, in free space or guided by fibers that are, for example, single-mode, and advantageously polarization-maintaining, from the mode splitter S to the photonic device C.

Advantageously, and as shown in FIGS. 3A and 3B, the photonic device C is configured to produce a first recombined light radiation Rc₁ from the first plurality of elementary light radiations R^{p}₁-R^{p}_{P} and to produce a second recombined light radiation Rc₂ from the second plurality of elementary light radiations R^{s}₁-R^{s}_{Q}. This configuration can be implemented by a single photonic device C, for example, a single photonic circuit PIC, or via two independent photonic devices (for example, two photonic circuits PIC1, PIC2) receiving the first and second plurality of elementary light radiations R^{p}₁-R^{p}_{P}, R^{s}₁-R^{s}_{Q}, respectively. More precisely, the first photonic device (e.g., a first photonic circuit PIC1) is optically coupled to the mode splitter S to receive the first plurality of elementary light radiations R^{p}₁-R^{p}_{P} and to produce the first recombined light radiation Rc₁. The second photonic device (e.g., a second photonic circuit PIC2) is optically coupled to the mode splitter S to receive the second plurality of elementary light radiations R^{s}₁-R^{s}_{P} and to produce the second recombined light radiation Rc₂. Wave plates or other polarization conditioning devices can be provided upstream and/or downstream of the photonic circuit PIC or the photonic circuits PIC1, PIC2 to adjust the polarization of the elementary radiations to that expected by the circuit(s).

As we have already seen, these optical couplings can be achieved in free space, via optical fibers such as polarization-maintaining single-mode fibers, or even by mechanically joining the photonic devices to the mode splitter S.

In a first alternative embodiment shown in FIG. 3A, the photonic device C comprises a recombination device R configured to recombine the first and second recombined radiation Rc₁, Rc₂ to form a single recombined light radiation R_{c} with a single polarization. In this configuration, the recombination device may consist of a Mach-Zehnder device or a polarizing beam splitter in reverse assembly. In this second case, the polarization of the single recombined light radiation R_{c} may be unstable and fluctuate over time. This variant is of particular interest when the polarization of the incident light radiation I is not multiplexed, since all the beam energy is placed in the single recombined light radiation R_{c} with a single polarization.

In a second embodiment shown in FIG. 3B, which is of interest when the polarization of the incident light radiation I is multiplexed, the photonic device C comprises a recombination device R configured to form a single recombined light radiation with two superimposed polarizations. In this configuration, the recombination device can be formed by a polarizing beam splitter in reverse assembly.

In each of the alternative embodiments shown in FIGS. 3A and 3B, the recombination device is completely optional. The photonic device C (and therefore the optical communication system 1) can be expected to deliver the first and second recombined radiation Rc₁, Rc₂ separately, that is, without recombining them with one another. In this case, the optical receiver OR can be equipped with two separate inputs for processing the radiation Rc₁ Rc₂ emitted by the optical communication system 1.

### Third Embodiment

The third embodiment is shown in FIG. 2D and is a variant of the second embodiment. It can therefore be applied under the same conditions of use, with the same benefits.

In this third embodiment, the polarizing beam splitter PBS is arranged in the optical port P of the telescope T, upstream of the multimode waveguide F. The polarizing beam splitter PBS is arranged to inject the first polarized light radiation R1p into a first polarization-maintaining multimode waveguide F1 and to inject the second polarized light radiation R1s into a second polarization-maintaining multimode waveguide F2. As in the second embodiment, a modal decomposition device M of the mode splitter S is configured to decompose the first polarized light radiation R1p supplied by the first multimode waveguide F1 into a first plurality of elementary light radiations R^{p}₁-R^{p}_{P}. It is also configured to decompose the second polarized light radiation Ris supplied by the second multimode waveguide F2 into a second plurality of elementary light radiations R^{s}₁-R^{s}_{Q}. The splitter S may feature a polarization conditioning device or a plurality of such devices, as detailed in an earlier section of this description.

The modal decomposition device M can also be formed by two independent devices, for example, two secondary MPLC devices M1, M2 independent of one another, or by a single modal decomposition device M, as in the second embodiment. The photonic device C can be implemented according to any of the variants shown in relation to the description of FIGS. 3A and 3B.

In the above embodiments, the incident light radiation I has a polarization that may need to be determined. However, this situation is not common. In particular, this is not the case when the communication protocol does not impose any particular polarization on the incident radiation I, or when the transmitter SAT is mobile in a frame of reference linked to the optical communication system 1.

In order to address this situation, and as already mentioned in the general presentation of this description, the optical port P of the telescope T can be equipped with a device for conditioning the polarization of the incident light radiation I. This conditioning device can in particular be integrated into the optical port P of the telescope T, in order to process the incident light radiation I before injecting it into the waveguide F in order to impose a determined polarization.

Naturally, the disclosure is not limited to the embodiments described, and it is possible to add alternative embodiments without departing from the scope of the invention as defined by the claims.

1. A free-space optical telecommunication system, comprising:
a telescope having an objective lens for collecting incident light radiation and producing, at an optical port, a first light radiation;
an optical processing device comprising:
a mode splitter comprising a modal decomposition device configured to decompose the first light radiation, the mode splitter producing a plurality of elementary light radiations; and
a photonic device optically coupled to the mode splitter, the photonic device being configured to coherently recombine at least some of the plurality of elementary light radiations and produce at least one recombined light radiation; and
at least one polarization-maintaining multimode waveguide with a first end coupled to the optical port of the telescope and a second end coupled to the optical processing device.

2. The optical telecommunication system of claim 1, wherein the modal decomposition device comprises at least one multiplane conversion device.

3. The optical telecommunication system of claim 1, wherein the modal decomposition device comprises a bundle of single-mode optical fibers assembled in parallel with one another.

4. The optical telecommunication system of claim 1, wherein the modal decomposition device preserves at least one polarization state of light radiation propagating therein, and the mode splitter comprises a polarization-conditioning device configured to conform the first light radiation to the preserved at least one polarization state of the modal decomposition device.

5. The optical telecommunication system of claim 1, comprising a polarizing beam splitter arranged upstream of the photonic device, the mode splitter producing a first plurality of elementary light radiations and a second plurality of elementary light radiations having distinct polarizations, the first and second plurality of elementary light radiations constituting the plurality of elementary light radiations.

6. The optical telecommunication system of claim 5, wherein the polarizing beam splitter is coupled to the second end of the at least one polarization-maintaining multimode waveguide, the polarizing beam splitter producing a first polarized light radiation and a second polarized light radiation with distinct polarizations.

7. The optical telecommunication system of claim 5, wherein the polarizing beam splitter is arranged in the optical port of the telescope to produce a first polarized light radiation and a second polarized light radiation having distinct polarizations, the polarizing beam splitter being arranged in the optical port to inject the first polarized light radiation into a first polarization-maintaining multimode waveguide and to inject the second polarized light radiation into a second polarization-maintaining multimode waveguide.

8. The optical telecommunication system of claim 6, wherein the mode splitter comprises a first modal decomposition device arranged to receive the first polarized light radiation and produce a first plurality of elementary light radiations and a second modal decomposition device arranged to receive the second polarized light radiation and produce a second plurality of elementary light radiations, the first and second pluralities of elementary light radiations constituting the plurality of elementary light radiations produced by the mode splitter.

9. The optical telecommunication system of claim 5, wherein the modal decomposition device is coupled to the second end of the at least one polarization-maintaining multimode waveguide to produce a plurality of decomposed light radiations and the polarizing beam splitter is optically disposed downstream of the modal decomposition device to receive the plurality of decomposed light radiations and produce the first plurality of elementary light radiations and the second plurality of elementary light radiations.

10. The optical telecommunication system of claim 5, wherein the photonic device is configured to produce a first recombined light radiation from the first plurality of elementary light radiations and to produce a second recombined light radiation from the second plurality of elementary light radiations.

11. The optical telecommunication system of claim 10, wherein the photonic device comprises a first photonic device optically coupled to the mode splitter for receiving the first plurality of elementary light radiations and producing the first recombined light radiation and a second photonic device optically coupled to the mode splitter for receiving the second plurality of elementary light radiations and producing the second recombined light radiation.

12. The optical telecommunication system of claim 10, wherein the photonic device comprises a recombination device configured to recombine the first and second recombined radiation and form a single recombined light radiation.

13. The optical telecommunication system of claim 1, wherein the optical port comprises a device for static or dynamic control of polarization of incident radiation to conform it to a determined polarization before it is injected into the at least one polarization-maintaining multimode waveguide.

14. The optical telecommunication system of claim 1, wherein the photonic device is optically coupled to the mode splitter via a plurality of single-mode optical fibers.

15. The optical telecommunication system of claim 1, wherein the mode splitter comprises a shaping device arranged upstream of the modal decomposition device.

16. The optical telecommunication system of claim 1, wherein the second end of the at least one polarization-maintaining multimode waveguide is directly coupled to an input port of the mode splitter.

17. The optical telecommunication system of claim 2, wherein the modal decomposition device comprises a bundle of single-mode optical fibers assembled in parallel with one another.

18. The optical telecommunication system of claim 17, wherein the modal decomposition device preserves at least one polarization state of light radiation propagating therein, and the mode splitter comprises a polarization-conditioning device configured to conform the first light radiation to the preserved at least one polarization state of the modal decomposition device.

19. The optical telecommunication system of claim 18, comprising a polarizing beam splitter arranged upstream of the photonic device, the mode splitter producing a first plurality of elementary light radiations and a second plurality of elementary light radiations having distinct polarizations, the first and second plurality of elementary light radiations constituting the plurality of elementary light radiations.

20. The optical telecommunication system of claim 7, wherein the mode splitter comprises a first modal decomposition device arranged to receive the first polarized light radiation and produce a first plurality of elementary light radiations and a second modal decomposition device arranged to receive the second polarized light radiation and produce a second plurality of elementary light radiations, the first and second pluralities of elementary light radiations constituting the plurality of elementary light radiations produced by the mode splitter.
